(19) United States
(12) Patent Application Publication
(10) Pub. No.: US 2018/0222246 A1
(43) Pub. Date: Aug. 9, 2018

(54) CONTAINER WITH A MAGNETIC REWRITEABLE DISPLAY SURFACE

(71) Applicant: Eric Lee Martin, Los Angeles, CA (US)

(72) Inventor: Eric Lee Martin, Los Angeles, CA (US)

(21) Appl. No.: 15/887,745

(22) Filed: Feb. 2, 2018

Related U.S. Application Data
(60) Provisional application No. 62/454,219, filed on Feb. 3, 2017.
(60) Provisional application No. 62/545,033, filed on Aug. 14, 2017.

(51) Int. Cl. B43L 1/00; G09F 9/37; B65D 51/24

(52) U.S. Cl. CPC B43L 1/008; G02F 2001/094; B65D 51/24; G09F 9/375

(57) ABSTRACT

A container for storing items may include a container body; a lid designed to engage with the container body; and a rewriteable magnetic display built into the lid or the container body. The rewriteable magnetic display may be removably attached to the lid or container body. Moreover, the container may include a stylus designed to create erasable marks on the rewriteable magnetic display. The container may also include food storage guidelines printed or otherwise displayed thereon.

### RELATED APPLICATION

This application claims priority to provisional patent application U.S. Ser. No. 62/454,219 filed on Feb. 3, 2017 and provisional patent application U.S. Ser. No. 62/545,033 filed on Aug. 14, 2017, the entire contents of each of which is herein incorporated by reference.

### BACKGROUND

The embodiments herein relate generally to storage containers, and more particularly, to a container with a magnetic rewriteable display surface.

Conventional containers do not provide a built in method for placing a temporary message or label, such as what is in the container, who it belongs to, if it has an expiration date, or a simple message, thereon. When users want to label conventional containers, they often have to use a writing tool and sticker to do so. However, this is wasteful and, if the user runs out of the stickers, the user may not be able to label a container when needed. Moreover, conventional labeling methods require use of adhesives, papers, inks, wipes, chalk, dry erasers, or the like. Labelling with these types of materials is consumptive, laborious, and in cases, permanent.

U.S. Pat. Nos. 5,018,979, 5,295,837, 5,112,229, 4,143,472, 3,229,281, 4,643,684, and 5,429503 the entire contents of each of which is incorporated herein by reference, describe an apparatus for providing a magnetic visual display. However, this technology has never been built into a container for labeling thereof.

Moreover, many individuals do not readily know the longest period of time that a food may be stored before it is not safe to consume. As a result, people tend to be wasteful by disposing of valuable food prematurely or, conversely, risk health by eating unsafe and spoiled food.

Therefore, what is needed is a container with a magnetic rewriteable display surface for placing a temporary message or label to identify contents, expirations, ownership, or the like, wherein the container may also include a food storage guideline.

### SUMMARY

Some embodiments of the present disclosure include a container for storing items may include a container body; a lid designed to engage with the container body; and a rewriteable magnetic display built into the lid or the container body. The rewriteable magnetic display may be removably attached to the lid or container body. Moreover, the container may include a stylus designed to create erasable marks on the rewriteable magnetic display. The container may also include food storage guidelines printed or otherwise displayed thereon.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of one embodiment of the present disclosure.

FIG. 2 is a perspective view of one embodiment of the present disclosure.

FIG. 3 is an exploded view of one embodiment of the present disclosure.

FIG. 4 is a bottom perspective view of one embodiment of the present disclosure.

FIG. 5 is a detail perspective view of one embodiment of the present disclosure.

FIG. 6 is a detail section view of one embodiment of the present disclosure, taken along line 6-6 in FIG. 1.

FIG. 7 is a detail section view of one embodiment of the present disclosure.

FIG. 8 is a detail section view of one embodiment of the present disclosure.

FIG. 9 is a perspective view of one embodiment of the present disclosure.

FIG. 10 is an exploded view of one embodiment of the present disclosure.

FIG. 11 is a section view of one embodiment of the present disclosure, taken along line 11-11 in FIG. 9.

FIG. 12 is a section view of one embodiment of the present disclosure.

FIG. 13 is a perspective view of one embodiment of the present disclosure.

FIG. 14 is a perspective view of one embodiment of the present disclosure.

FIG. 15 is a perspective view of one embodiment of the present disclosure.

FIG. 16 is a perspective view of one embodiment of the present disclosure.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used as a container with a magnetic rewriteable display surface and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

a. Container

b. Lid

c. Magnetic Rewriteable Display Surface

d. Magnetic Stylus

The various elements of the device of the present disclosure may be related in the following exemplary fashion. It is not intended to limit the scope or nature of the relationships between the various elements and the following examples are presented as illustrative examples only.

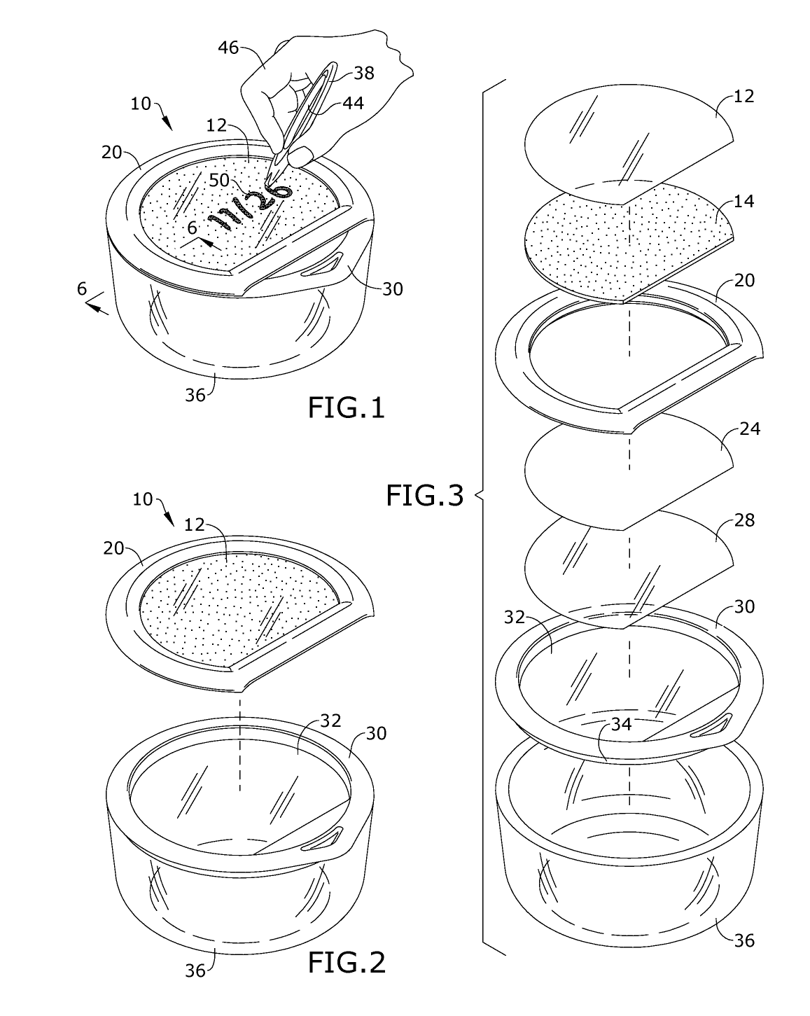

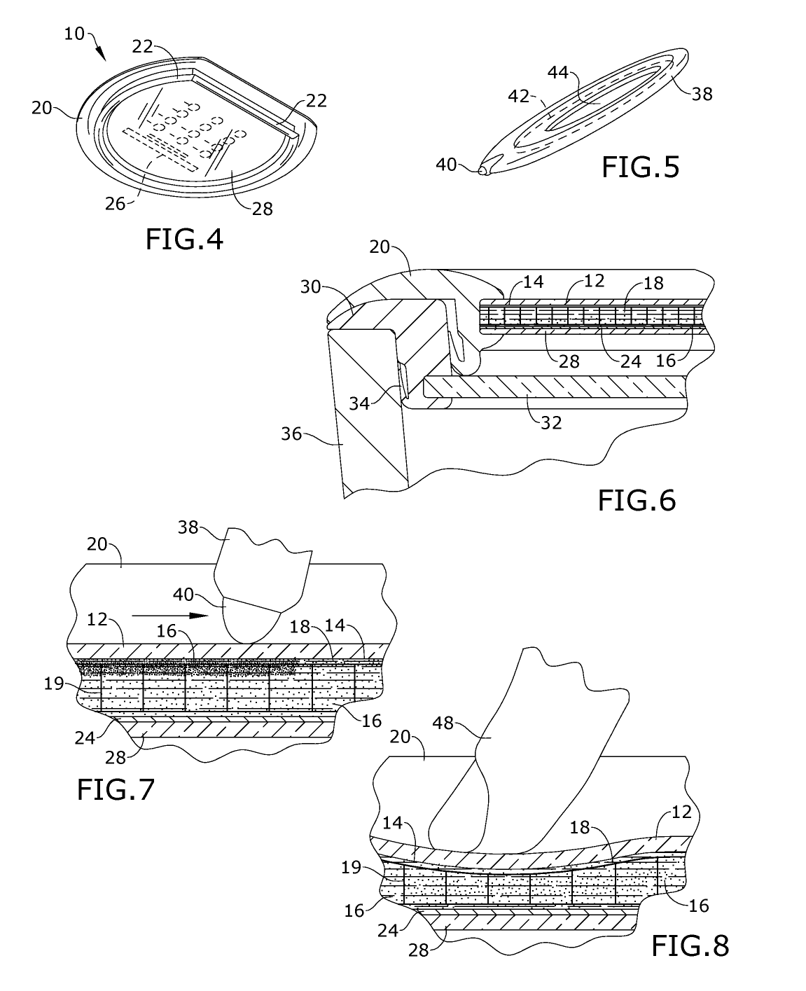

By way of example, and referring to FIGS. 1-16, some embodiments of the present disclosure include a container for storing items, the container comprising a container body, a lid designed to engage with the container body, and a magnetic rewriteable display built into a member selected from the group consisting of the lid and the container body. In embodiments, the container may further comprise a stylus 38 designed to interact with the rewriteable magnetic display to create a mark 50. The mark 50 may be created, for example, by a magnetic tip 40 of the stylus 38 attracting magnetic particles to an outer surface of the magnetic rewriteable display. To erase the mark, a user 46 may simply press down on the magnetic rewriteable display, causing the particles to be pulled away or dispersed from the outer surface.

For example, as shown in FIGS. 1-4 and 6-8, a magnetic rewriteable display may be built into a rewriteable lid 10 designed to engage with a container body 36. Specifically, the rewriteable lid 10 may comprise a housing 20 designed to engage with a lower lid housing 30, which is in turn designed to engage with an upper rim of the container body 36. The housing 20 may have a magnetophoretic display 14 mounted or otherwise attached thereto. A top clear panel 12 may optionally be attached to the housing 20 such that the magnetophoretic display 14 is sandwiched between the top clear panel 12 and an optional bottom clear panel 28. In some embodiments, a surface of the housing 20 opposite the magnetophoretic display 14 may have a food storage guideline label 24 attached thereto. Alternatively, the food storage guidelines may be printed directly on the surface of the magnetophoretic display 14 or the optional bottom clear panel 28 opposite the top clear panel 12. The bottom clear panel 28 may be attached to a surface of the housing 20 opposite the magnetophoretic display 14, such that the food storage guideline label 24 is sandwiched between the magnetophoretic display 14 and the bottom clear panel 28. Thus, the bottom clear panel 28 may serve as a protective covering for the food storage guideline label 24, wherein guideline text 26 may be visible through the bottom clear panel 28. The lower lid housing 30 may include an outer lid housing attachment lip 34 encircling a lower lid clear panel 32, wherein the lower lid housing attachment lip 34 is designed to removably engage with the container body 36 to removably attach the rewriteable lid 10 to the container body 36.

As shown in FIG. 6, the magnetophoretic display 14 may comprise a transparent enclosure filled with a magnetophoretic display fluid 18 containing metallic particles 16 and containment mesh 19 held within the magnetophoretic display fluid 18. As shown in FIG. 7, when a magnetic device, such as the magnetic tip 40 on stylus 38 is drawn across the magnetophoretic display 14 (or the optional top clear panel 12), the metallic particles 16 are drawn upwards and away from the area of the magnetophoretic display 14 proximate the bottom clear panel 28, creating a mark or written image 50 on the outermost surface of the magnetophoretic display 14. To erase the written image 50 a user 46 may simply press a top surface of the magnetophoretic display 14 with his or her finger 48, causing the metallic particles 16 to disperse back down into the magnetophoretic display fluid 18.

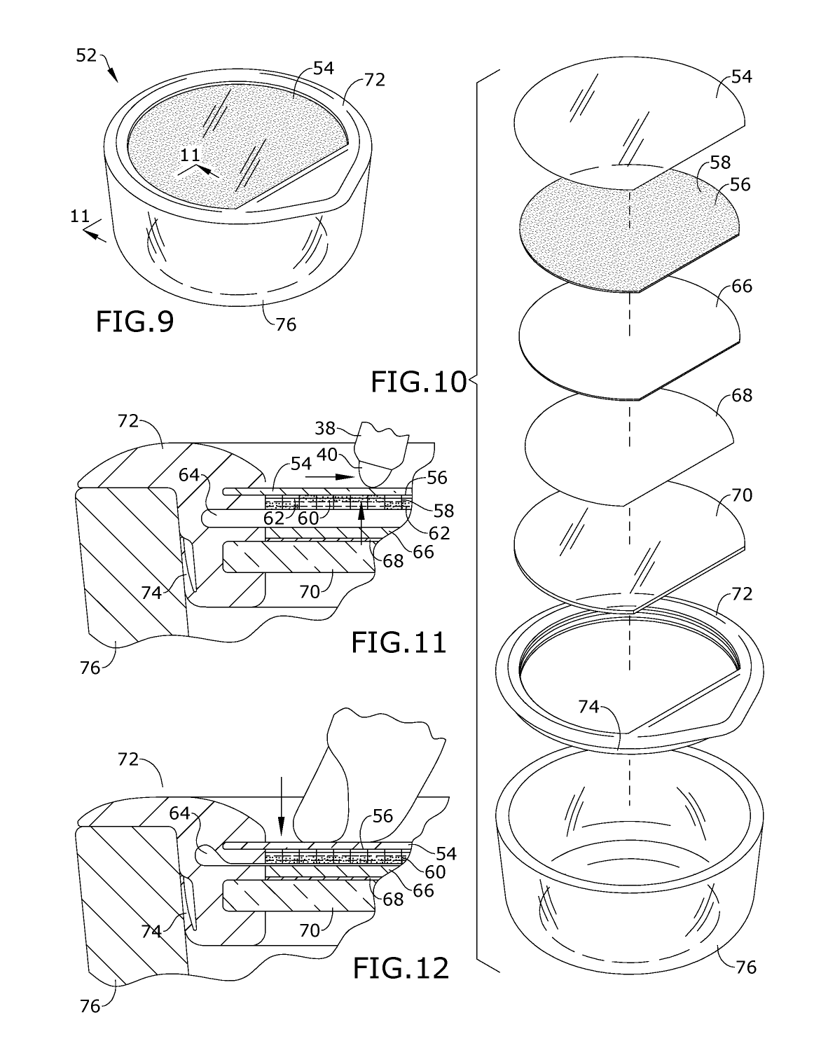

Alternatively, as shown for example in FIGS. 9-12, the container body 76 may engage with an alternate rewriteable lid assembly 52 comprising a lid housing 72 with an optional top clear panel 54 and a housing lip 74 designed to engage with an upper rim of the container body 76. The lid housing 72 may have an alternate magnetophoretic display 56 mounted or otherwise attached thereto, such that a user 46 may display a rewriteable written image 50 thereon. Specifically, as shown in FIG. 10, the lid housing 72 may be designed to hold, in order, a bottom clear lid panel 70, an optional food storage guideline label 68, a base magnet 66, the magnetophoretic display 56, and the optional top clear panel 54. As shown in FIG. 11, when pressure is not placed on the top clear panel 54 pressing it toward the bottom clear lid panel 70, an air gap slot 64 may be positioned between the base magnet 66 and the alternate magnetophoretic display 56. The alternate magnetophoretic display 56 may comprise a plurality of cells 58, a display fluid 62, such as an opaque or clear display fluid, filling the plurality of cells 58, and metallic particles 60 suspended within the display fluid 62. As shown in FIG. 11, when a magnetic device, such as the magnetic tip 40 of stylus 38, is drawn across the outermost surface of the top clear panel 54 or the magnetophoretic display 56, the metallic particles 60 may be drawn toward the top clear panel 54, creating a written image 50. To erase the written image 50, a user 46 may press down with his or her finger, causing the air gap slot 64 to depress, resulting in the base magnet 66 coming close to a bottom surface of the magnetophoretic display 56. As a result, the metallic particles 60 are pulled downward from the surface of the magnetophoretic display 56 proximate to the top clear panel 54, causing the written image 50 to be erased. While the drawings show the base magnet 66 as a planar structure mimicking the size and shape of the magnetophoretic display 56, other embodiments of this base magnet 66 are envisioned. Specifically, the base magnet 66 may be an elongate item designed to slide underneath the magnetophoretic display 56 using a lever and a knob. Alternatively, the magnetophoretic display 56 may be rotated with respect to the base magnet 66 to attract the metallic particles 60 to the base magnet 66, as well as rotated back to reset the drawings surface. In such cases, the lid may comprise two housings, one of which houses the magnetophoretic display and the second of which houses the base magnet. The two housings may be operatively and rotationally attached to each other by way of a screw-like, step, or notch structure. When one housing is rotated with respect to the other, an air gap is provided, resetting the drawing surface by releasing the metallic particles from the magnetic field of the base magnet.

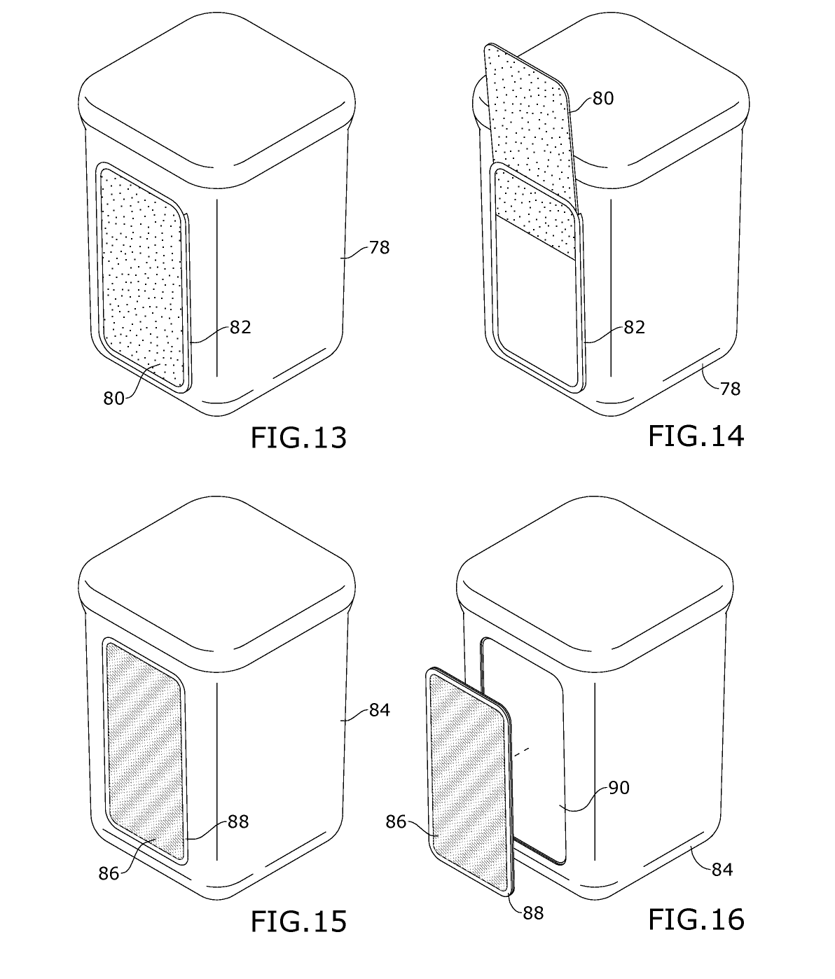

Instead of the container lid including the magnetophoretic display, it may be removably attached or secured to the container body. For example, as shown in FIGS. 13 and 14, the container body 78 may include a display slot 82 attached or built into one of the walls of the container body 78. The magnetophoretic display 80 may simply slide or otherwise be enclosed within the display slot 82. Alternatively, as shown in FIGS. 15 and 16, the container body 84 may include a container recess 90 in at least one of the walls, wherein the container recess 90 is sized to accommodate the magnetophoretic display 86, which may include a display attachment lip 88 extending from the outer edges thereof, the display attachment lip 88 designed to engage with the container recess 90 and hold the magnetophoretic display therein.

In any case, the magnetic rewriteable display may be removably attached to the lid or container body, allowing for microwaving of the container and lid, washing of the container or lid, and the like. In some embodiments, the magnetophoretic display may be contained between the top clear panel and the bottom clear panel under high atmospheric pressure to prevent the display liquid from freezing or boiling when exposed to extreme temperatures.

The magnetic rewriteable display may be used with any desired magnetic device, such as a magnetic tip stylus. In some embodiments and as shown in FIG. 5, the stylus 38 may include an elongate body with a center orifice 44, an internal magnet 42 built into the elongate body, and a magnetic tip 40.

The container of the present disclosure may be made of any suitable or desired materials. In some embodiments, the magnetophoretic display may be housed in, for example, plastic or silicone. The clear panels may comprise a protective glass or plastic layer. The container body may have any desired shape or size such that any desired items may be stored therein.

The food storage guidelines may be attached, adhered, or printed on any surface of the container or lid. While these guidelines are optional, they may be useful for reminding or educating the user of food expirations.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A container for storing items, the container comprising:
a container body;
a lid designed to engage with the container body; and
a rewriteable magnetic display built into a member selected from the group consisting of the lid and the container body.

2. The container of claim 1, further comprising a stylus designed to interact with the rewriteable magnetic display to create a mark, the stylus comprising an elongate body with a center orifice, an internal magnet housed within the elongate body, and a magnetic tip.

3. The container of claim 1, wherein the rewriteable magnetic display comprises:
a transparent enclosure;
magnetophoretic display fluid filling the transparent enclosure;
containment mesh held within the magnetophoretic display fluid; and
metallic particles suspended in the magnetophoretic display fluid.

4. The container of claim 1, wherein the rewriteable magnetic display comprises:
a top clear panel;
a base magnet;
a magnetophoretic display positioned between the top clear panel and the base magnet; and
an air gap slot positioned between the base magnet and the magnetophoretic display.

5. The container of claim 4, wherein the magnetophoretic display comprises:
a plurality of cells;
a display fluid filling the plurality of cells; and
metallic particles suspended within the display fluid.

6. The container of claim 1, further comprising a food storage guideline attached to a surface of a member selected from the group consisting of the lid and the container body.

7. The container of claim 1, wherein the rewriteable magnetic display is removably attached to the member selected from the group consisting of the lid and the container body.

8. The container of claim 7, wherein:
the rewriteable magnetic display is removably attached to the container body;
the container body comprises a display slot attached thereto; and
the display slot is sized to accommodate the rewriteable magnetic display.

9. The container of claim 7, wherein:
the rewriteable magnetic display is removably attached to the container body;
the container body comprises a container recess sized to accommodate the rewriteable magnetic display; and
the rewriteable magnetic display comprises a display attachment lip extending from outer edges thereof, the display attachment lip designed to engage with the container recess.
